(19) United States
(12) Patent Application Publication
(10) Pub. No.: US 2018/0158245 A1
(43) Pub. Date: Jun. 7, 2018

(54) SYSTEM AND METHOD OF INTEGRATING AUGMENTED REALITY AND VIRTUAL REALITY MODELS INTO ANALYTICS VISUALIZATIONS

(71) Applicant: SAP SE, Walldorf (DE)

(72) Inventor: Nandagopal Govindan, Bangalore (IN)

(21) Appl. No.: 15/370,887

(22) Filed: Dec. 6, 2016

(51) Int. Cl. G06T 19/00; G06T 17/20; G06T 15/00; G06T 11/20; H04N 13/04; G06F 17/30

(52) U.S. Cl. CPC G06T 19/006; G06T 17/20; G06T 15/005; G06T 11/206; G06F 3/04815; G06F 17/30554; G06F 17/30572; G06F 17/30277; G06F 17/30256; H04N 13/044

(57) ABSTRACT

Techniques of integrating augmented reality and virtual reality models in analytics visualizations are disclosed. An embodiment comprises receiving a query for data from an analytics platform and then processing the query. The processing includes extracting information from the query and receiving query results. The embodiment also comprises generating, based on the query results, a 2D report and converting the 2D report into a 3D model. The converting includes plotting points from the 2D report in 3D space and exporting the 3D model using a 3D format. The embodiment further comprises loading the 3D model into one or more of: an augmented reality (AR) environment; and a virtual reality (VR) environment; and rendering, in a graphical user interface of a user device, a visualization of the 3D model.

### TECHNICAL FIELD

The present application relates generally to the technical field of data processing, and, in various embodiments, to systems and methods of integrating augmented reality and virtual reality models into analytics visualizations.

### BACKGROUND

In conventional data analysis tools, it can be difficult for analysts and business users to know what the best next step to take is or decision to make when navigating or exploring data. This feeling of being lost in the data results in a less powerful analysis experience, as well as a higher degree of frustration and, potentially, wasted time. Traditional data analysis tools do not integrate augmented reality and virtual reality models in analytics reports. Such reports are of limited help when an analyst wishes to view the current state of analytics data using augmented reality (AR) and virtual reality (VR) models, headsets, and other AR or VR input/output devices.

Conventional analytics products are not integrated with AR- or VR-based analytics products or with personal analytics tools. Traditional Business intelligence based analytics products focus on B2B customers and not B2C customers, who are mobile-centric. AR- and VR-based products are mobile-centric. Thus, there is a need for analytics reports in the AR and VR environments in order to provide personal analytics reports and solutions. Conventional analytics reports are web-based 2D reports and not explored in 3D space. As such, it is desirable to produce 3D analytics reports with data visualizations and user experiences that are not available using traditional techniques.

### BRIEF DESCRIPTION OF THE DRAWINGS

Some example embodiments of the present disclosure are illustrated by way of example and not limitation in the figures of the accompanying drawings, in which like reference numbers indicate similar elements, and in which:

FIG. 1 is a network diagram illustrating a client-server system, in accordance with some example embodiments;

FIG. 2 is a block diagram illustrating enterprise applications and services in an enterprise application platform, in accordance with some example embodiments;

FIG. 3 is a flowchart illustrating a method of using an analytics engine to execute a received query, in accordance with some example embodiments;

FIG. 4 is a flowchart illustrating a method of using an improved analytics engine to integrate augmented reality (AR) and virtual reality (VR) models in analytics visualizations, in accordance with some example embodiments;

FIG. 5 is a flowchart illustrating a method of converting two-dimensional (2D) reports into three-dimensional (3D) reports and providing interactive AR and VR visualizations of the 3D models, in accordance with some example embodiments;

FIG. 6 is a flowchart illustrating a method of converting data points from 2D reports into 3D data models, in accordance with some example embodiments;

FIG. 7 depicts extraction and plotting of data points from a 2D analytics report to export an example 3D model, in accordance with some example embodiments;

FIG. 8 illustrates example 3D models of analytics visualizations displayed in an AR environment, in accordance with some example embodiments;

FIG. 9 depicts displaying an example 3D model of an analytics visualization output as the result of a text or image query in a VR environment, in accordance with some example embodiments;

FIG. 10 depicts displaying an example 3D model of an analytics visualization output as the result of a voice query in a VR environment, in accordance with some example embodiments;

FIG. 11 depicts displaying an example 3D model of an analytics visualization output as the result of a query input in a VR environment, in accordance with some example embodiments;

FIG. 12 illustrates an example 3D analytics visualization displayed in a VR environment, in accordance with some example embodiments;

FIG. 13 illustrates an example 3D model of an analytics visualization displayed in an AR environment, in accordance with some example embodiments;

FIG. 14 illustrates an example 3D analytics visualization displayed in a VR environment, in accordance with some example embodiments;

FIG. 15 illustrates example 3D models of analytics visualizations displayed in an AR environment, in accordance with some example embodiments;

FIG. 16 is a block diagram illustrating a mobile client device on which VR and AR visualizations described herein can be executed, in accordance with some example embodiments; and

FIG. 17 is a block diagram of an example computer system on which methodologies described herein can be executed, in accordance with some example embodiments.

### DETAILED DESCRIPTION

Example methods and systems of integrating augmented reality (AR) and virtual reality (VR) models in analytics visualizations are disclosed. In the following description, for purposes of explanation, numerous specific details are set forth in order to provide a thorough understanding of example embodiments. It will be evident, however, to one skilled in the art that the present embodiments can be practiced without these specific details.

The present disclosure provides features that assist users with decision-making by integrating AR and VR models in analytics visualizations. In particular, example methods and systems generate and present analytical and decision-support reports in the form of AR and VR visualizations. In some embodiments, the AR and VR visualizations are presented as bar charts that are both visually intuitive and contextually relevant. These features provide new modes of interaction with data that make data analysis and decision-making experiences more intuitive and efficient. A unique level of assistance is provided to analysts and other users who are performing the very complex task of data exploration. Instead of simply providing 2D reports and leaving it to analysts to manually identify key patterns over time leading to the current state of measured metrics via trial and error, the system of the present disclosure generates 3D AR and VR representations that convey changes in the metrics more intuitively.

Embodiments provide 3D reports for use with data visualization, user experience, and personal analytics in VR and AR environments. Such AR- and VR-based analytics are mobile-centric. In this way, personal analytics is achieved with embodiments described herein.

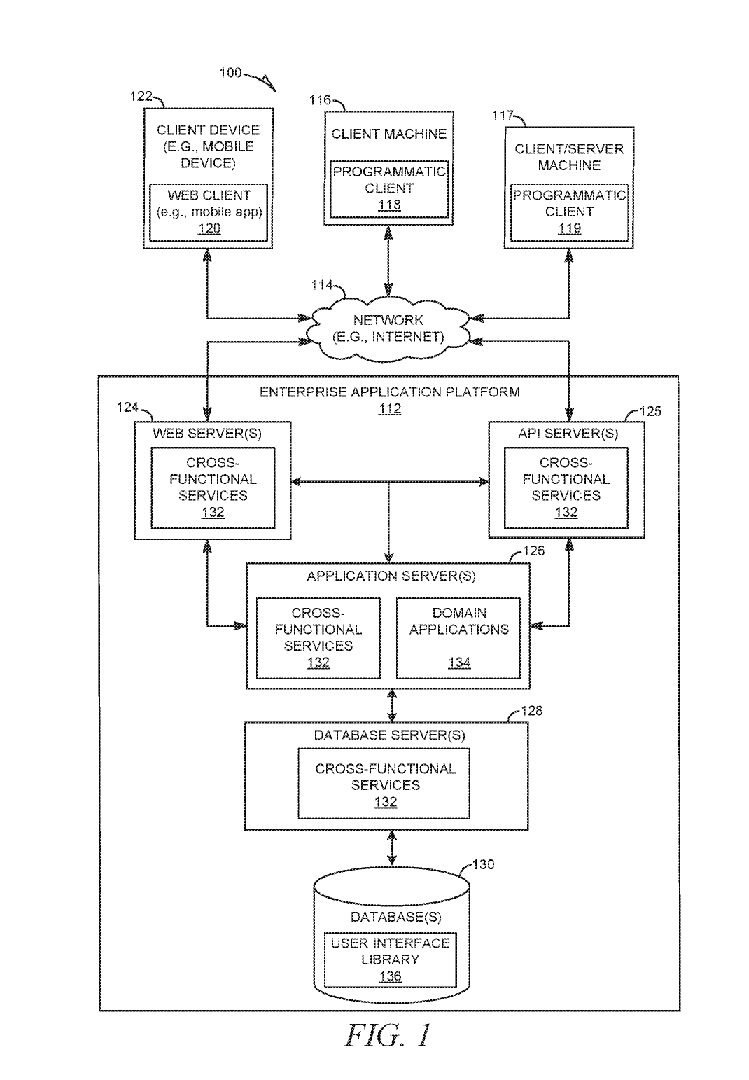

FIG. 1 is a network diagram illustrating a client-server system 100, in accordance with some example embodiments. The client-server system 100 can be used to integrate AR and VR models in analytics visualizations such as analytical and decision-support reports. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser), a small device client machine 122 (e.g., a mobile device) with a web client 120 (e.g., a mobile-device browser or a browser without a script engine), and a client/server machine 117 with a programmatic client 119. In the example of FIG. 1, the web client 120 can be a mobile app configured to render AR and VR visualizations.

Turning specifically to the example enterprise application platform 112, web servers 124 and Application Programming Interface (API) servers 125 can be coupled to, and provide web and programmatic interfaces respectively to, application servers 126. The application servers 126 can be, in turn, coupled to one or more database servers 128 that facilitate access to one or more databases 130. The web servers 124, API servers 125, application servers 126, and database servers 128 can host cross-functional services 132. The cross-functional services 132 can include relational database modules to provide support services for access to the database(s) 130, which includes a user interface library 136. The application servers 126 can further host domain applications 134.

The cross-functional services 132 provide services to users and processes that utilize the enterprise application platform 112. For instance, the cross-functional services 132 can provide portal services (e.g., web services), database services and connectivity to the domain applications 134 for users who operate the client machine 116, the client/server machine 117 and the small device client machine 122. In addition, the cross-functional services 132 can provide an environment for delivering enhancements to existing applications and for integrating third-party and legacy applications with existing cross-functional services 132 and domain applications 134. Further, while the system 100 shown in FIG. 1 employs a client-server architecture, the embodiments of the present disclosure are of course not limited to such an architecture, and could equally well find application in a distributed, or peer-to-peer, architecture system.

The enterprise application platform 112 can implement partition-level operation with concurrent activities. For example, the enterprise application platform 112 can implement a partition-level lock, implement a schema lock mechanism, manage activity logs for concurrent activity, generate and maintain statistics at the partition level, and efficiently build global indexes.

In addition, the modules of the enterprise application platform 112 can comply with web services standards and/or utilize a variety of Internet technologies including Java, J2EE, SAP's Advanced Business Application Programming (ABAP) language and Web Dynpro, XML, JCA, JAAS, X.509, LDAP, WSDL, WSRR, SOAP, UDDI and Microsoft .NET.

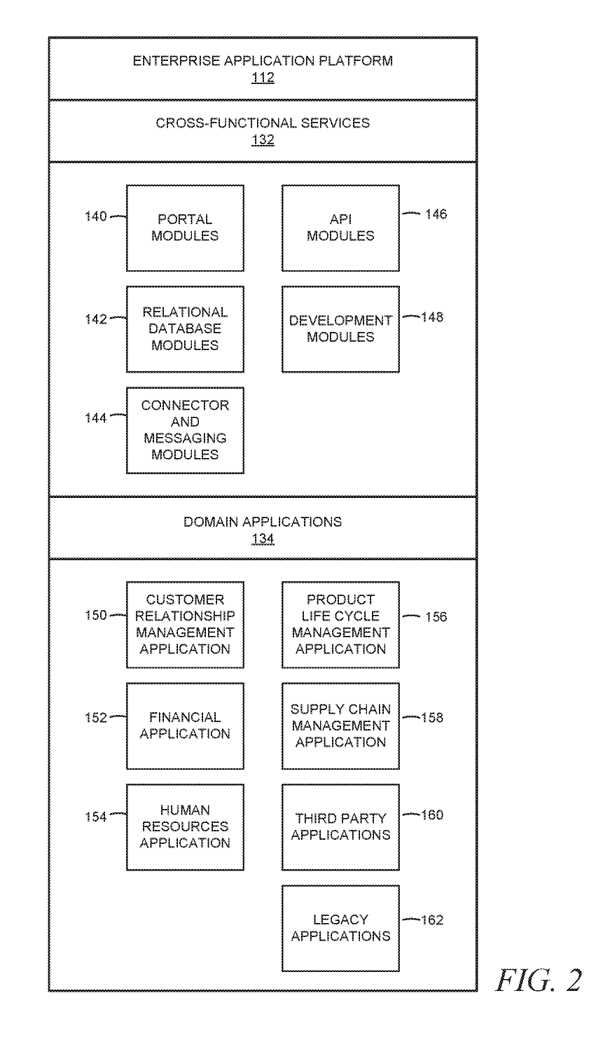

FIG. 2 is a block diagram illustrating enterprise applications and services in an enterprise application platform 112, in accordance with an example embodiment. The enterprise application platform 112 can include cross-functional services 132 and domain applications 134. The cross-functional services 132 can include portal modules 140, relational database modules 142, connector and messaging modules 144, API modules 146, and development modules 148. The domain applications 134 can include customer relationship management applications 150, financial applications 152, human resources applications 154, product life cycle management applications 156, supply chain management applications 158, third-party applications 160, and legacy applications 162. The enterprise application platform 112 can be used to develop, host, and execute applications for integrating AR and VR models in analytics visualizations.

The portal modules 140 can enable a single point of access to other cross-functional services 132 and domain applications 134 for the client machine 116, the small device client machine 122, and the client/server machine 117. The portal modules 140 can be utilized to process, author, and maintain web pages that present content (e.g., user interface elements and navigational controls) to the user. In addition, the portal modules 140 can enable user roles, a construct that associates a role with a specialized environment that is utilized by a user to execute tasks, utilize services, and exchange information with other users and within a defined scope. For example, the role can determine the content that is available to the user and the activities that the user can perform. The portal modules 140 can include a generation module, a communication module, a receiving module, and a regenerating module (not shown). In addition, the portal modules 140 can comply with web services standards and/or utilize a variety of Internet technologies including Java, J2EE, SAP's ABAP language and Web Dynpro, XML, JCA, JAAS, X.509, LDAP, WSDL, WSRR, SOAP, UDDI and Microsoft .NET.

The relational database modules 142 can provide support services for access to the database(s) 130, which includes a user interface library 136. The relational database modules 142 can provide support for object relational mapping, database independence and distributed computing. The relational database modules 142 can be utilized to add, delete, update and manage database elements. In addition, the relational database modules 142 can comply with database standards and/or utilize a variety of database technologies including SQL, SQLDBC, Oracle, MySQL, Unicode, JDBC, or the like. In certain embodiments, the relational database modules 142 can be used to access business data stored in database(s) 130. For example, the relational database modules 142 can be used by a query engine to query database(s) 130 for analytics data needed to produce analytics visualizations that can be integrated with AR and VR models. In certain embodiments, the analytics data needed to produce analytics visualizations can be stored in database(s) 130. In additional or alternative embodiments, such data can be stored in an in-memory database or an in-memory data store. For example, the analytics data and the corresponding 3D analytics visualizations produced using the data can be stored in an in-memory data structure, data store, or database.

The connector and messaging modules 144 can enable communication across different types of messaging systems that are utilized by the cross-functional services 132 and the domain applications 134 by providing a common messaging application processing interface. The connector and messaging modules 144 can enable asynchronous communication on the enterprise application platform 112.

The API modules 146 can enable the development of service-based applications by exposing an interface to existing and new applications as services. Repositories can be included in the platform as a central place to find available services when building applications.

The development modules 148 can provide a development environment for the addition, integration, updating, and extension of software components on the enterprise application platform 112 without impacting existing cross-functional services 132 and domain applications 134.

Turning to the domain applications 134, the customer relationship management application 150 can enable access to, and can facilitate collecting and storing of, relevant personalized information from multiple data sources and business processes. Enterprise personnel that are tasked with developing a buyer into a long-term customer can utilize the customer relationship management applications 150 to provide assistance to the buyer throughout a customer engagement cycle.

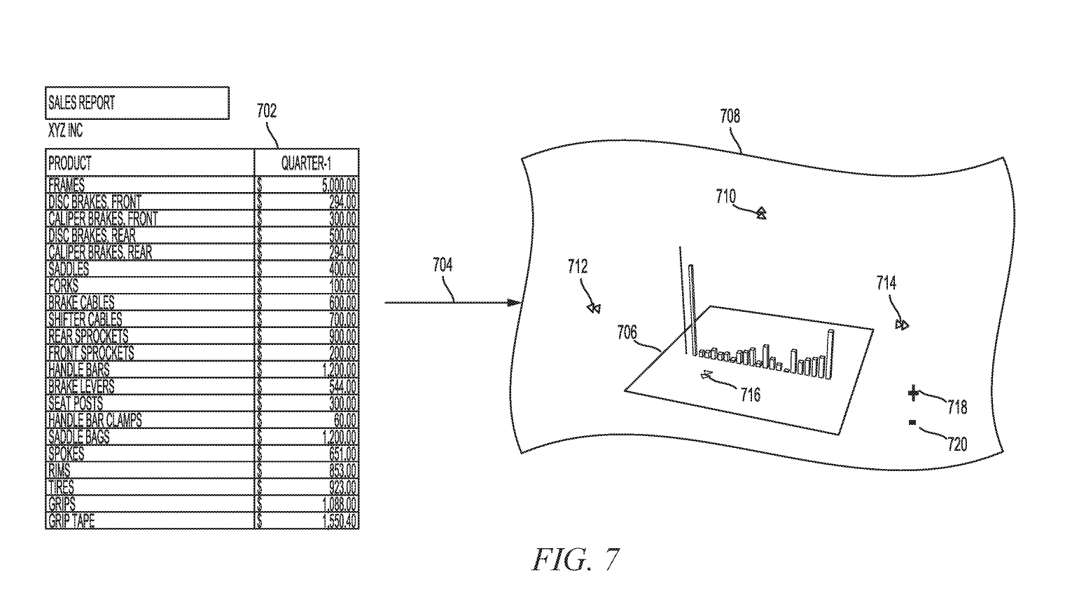

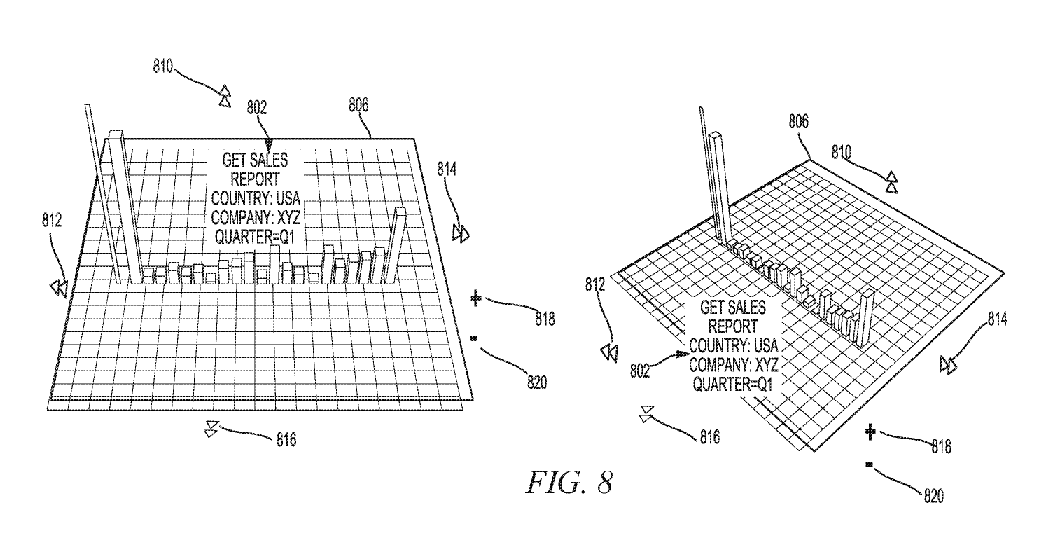

Enterprise personnel can utilize the financial applications 152 and business processes to track and control financial transactions within the enterprise application platform 112. The financial applications 152 can facilitate the execution of operational, analytical, and collaborative tasks that are associated with financial management. Specifically, the financial applications 152 can enable the performance of tasks related to financial accountability, planning, forecasting, and managing the cost of finance. The financial applications 152 can also provide financial data, such as, for example, sales data, as shown in FIGS. 7 and 8. Such data can be used to generate AR and VR visualizations depicting 3D financial data for an interval of time such as a quarter of a year.

The human resource applications 154 can be utilized by enterprise personnel and business processes to manage, deploy, and track enterprise personnel. Specifically, the human resource applications 154 can enable the analysis of human resource issues and facilitate human resource decisions based on real-time information.

The product life cycle management applications 156 can enable the management of a product throughout the life cycle of the product. For example, the product life cycle management applications 156 can enable collaborative engineering, custom product development, project management, asset management, and quality management among business partners.

The supply chain management applications 158 can enable monitoring of performances that are observed in supply chains. The supply chain management applications 158 can facilitate adherence to production plans and on-time delivery of products and services.

The third-party applications 160, as well as legacy applications 162, can be integrated with domain applications 134 and utilize cross-functional services 132 on the enterprise application platform 112.

### Example Methods

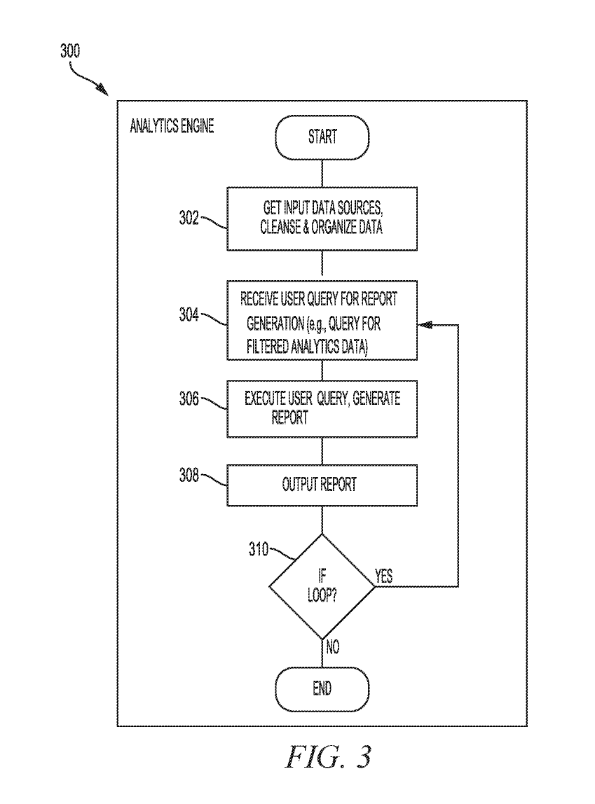

FIG. 3 is flowchart illustrating a method 300 performed by an analytics engine for generating analytics reports. Reports with three dimensions (e.g., data points plotted along x, y, and z axes) can be visualized in a 2D format, such as a 2D report produced by method 300. However, the 2D reports generated by method 300 may not be suitable in certain AR and VR environments.

Method 300 can be performed by processing logic that can comprise hardware (e.g., circuitry, dedicated logic, programmable logic, microcode, etc.), software (e.g., instructions run on a processing device), or a combination thereof. In one example embodiment, the method 300 is performed by the system 100 of FIG. 1 or any combination of one or more of its respective components or modules, as described above. As shown, operations 302-310 can be performed by an analytics engine.

At operation 302, input data sources can be received. In the example of FIG. 3, operation 302 can include cleansing and organizing the received data.

At operation 304, a user query for a report can be received. As shown in FIG. 3, operation 304 can include receiving a user query for generating a report based on filtered analytics data. In some embodiments, the analytics data can include data from a data feed of an analytics platform. In certain embodiments, the analytics data can include measured values, such as for example, sales, revenue, profits, taxes, expenses, defects, average order size, raw materials, and logistics for a company in a given time period. In these embodiments, the time period can be one or more days, weeks, months, quarters, years, or other durations. In some embodiments, the data from the data feed and the analytics data can be stored in an in-memory database or an in-memory data store.

At operation 306, the received query is executed and a corresponding report is generated. In an embodiment, operation 306 includes extracting information from the query such as query parameters (e.g., a time parameter and measures to be queried), sending, to an analytics platform, the extracted information, executing, by the analytics platform, the query, receiving, from the analytics platform, the query results, and generating, based on the query results, the report. The report generated by operation 306 can be a 2D report, such as, for example the 2D report 702 shown in FIG. 7.

At operation 308, the generated report is output. This operation can include rendering a 2D report on a display device of a user device, such as, for example, a mobile device. Operation 308 can include rendering the report based on hardware visualization. For example, the report generation can be based on resolution of the user device's display unit and the shape and dimensions of the display unit (e.g., curved, linear, aspect ratio). The target user device can be any mobile device, laptop, tablet device, or desktop computer. The display device can be a dashboard including one or multiple screens.

At operation 310, a determination is made as to whether additional processing is to be performed. The determination in operation 310 can be based on user input requesting an additional report, or user input indicating that the method 300 can be terminated. If it is determined that there is additional processing to be performed (e.g., based on user input of a new or modified query), control is passed back to operation 304. Otherwise, the method 300 ends.

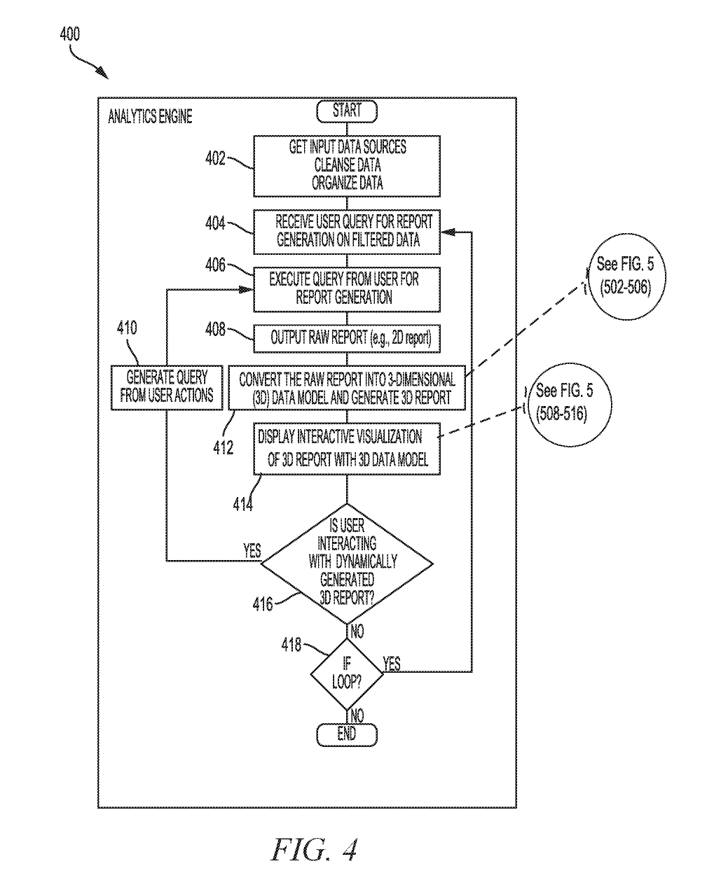

FIGS. 4-6 depict methods 400, 500, and 600 performed by an improved analytics engine that is integrated with AR and VR environments. In particular. In particular, FIG. 4 is a flowchart illustrating a method 400 of using an improved analytics engine to integrate augmented reality (AR) and virtual reality (VR) models in analytics visualizations.

Method 400 can be performed by processing logic that can comprise hardware (e.g., circuitry, dedicated logic, programmable logic, microcode, etc.), software (e.g., instructions run on a processing device), or a combination thereof. In one example embodiment, the method 400 is performed by the system 100 of FIG. 1 or any combination of one or more of its respective components or modules, as described above. As shown, operations 402-418 can be performed by an analytics engine.

At operation 402, input data sources can be received. In the example of FIG. 4, operation 402 can include cleansing and organizing the received data.

At operation 404, a user query for a report can be received. As depicted in FIG. 4, operation 404 can include receiving a user query for generating a report based on filtered data. In certain embodiments, the filtered data can be analytics data from a data feed of an analytics platform (e.g., a platform including an analytics engine). In some embodiments, the analytics data can include web analytics and other measures of user context for a time period, such as, for example, sales, revenue, numbers of visitors, conversions, click through rate, average time spent on site, profits, taxes, expenses, defects, average order size, raw materials, and logistics for an entity such as a web site or a company. In these embodiments, the time period can be one or more hours, days, weeks, months, quarters, years, or other durations.

At operation 406, the received query is executed and a corresponding raw report is generated. In an embodiment, operation 406 includes extracting information from the query such as query parameters (e.g., a time parameter and one or more measures to be queried), sending, to an analytics platform, the extracted information, executing, by the analytics platform, the query, receiving, from the analytics platform, the query results, and generating, based on the query results, the raw report. The raw report generated by operation 406 can be a 2D report, such as, for example the 2D report 702 illustrated in FIG. 7.

At operation 408, the generated raw report is output. This operation can include providing the raw report to a user device, such as, for example, a mobile device.

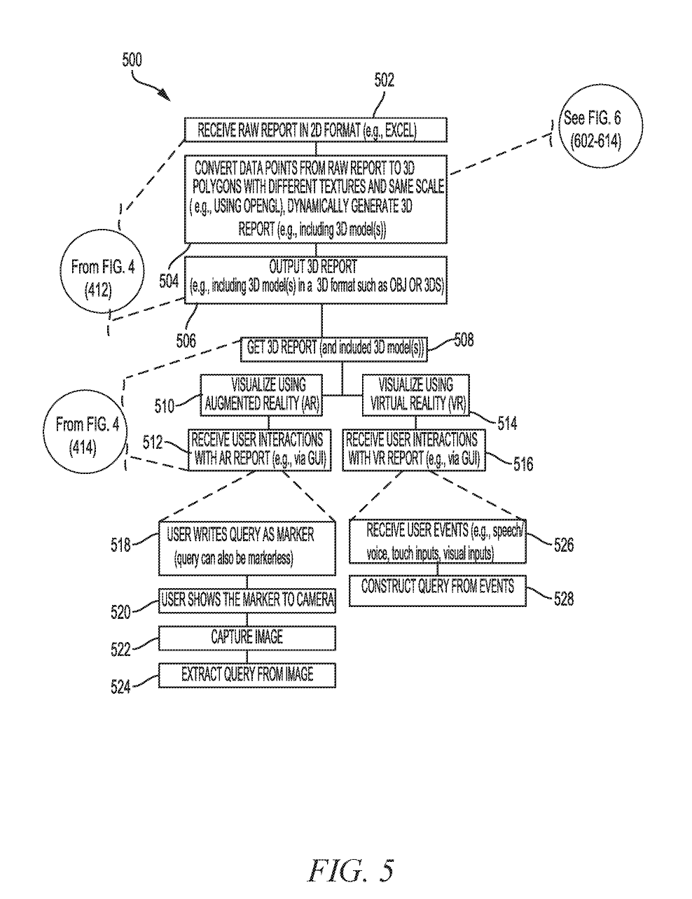

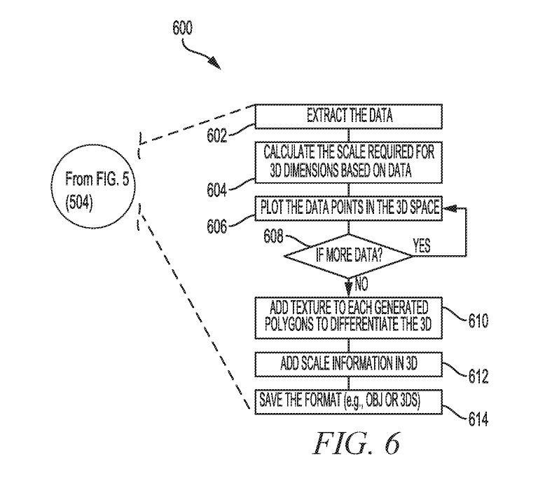

At operation 412, the raw report is converted into a 3D data model. The 3D data model can be incorporated into a 3D report that is generated as part of operation 412. Converting the raw report can include converting a 2D report into the 3D report. Sub-operations for operation 412 are described in detail with reference to FIGS. 5 and 6 below. The converting in operation 412 can comprise using an application programming interface (API) for rendering 3D computer graphics such as, for example, OpenGL, OpenGL for Embedded Systems (OpenGL ES), or other graphics-based libraries, to plot data points in the 2D report in 3D space, and this process can continue until all data points from the 2D report are plotted. Then, operation 412 can include generating 3D polygons with different textures. Scale information can also captured for 3D objects that are to be included in the 3D report.

Operation 412 can include plotting points from the raw report (e.g., a 2D report) in 3D space and exporting the 3D model using a 3D format. In some embodiments, the exporting of operation 412 can be performed using an Open Asset Import Library (Assimp) format, a 3ds Max format, a lib3ds library format (e.g., 3DS), or another 3D format usable to render the 3D data model in a graphical user interface of a user device. In some embodiments, operation 412 can include generating one or more polygons, each of the one or more polygons having respective, different textures, and capturing scaling information for 3D objects included in the 3D model. Additional details and sub-operations that can be performed to accomplish operation 412 are provided in FIG. 5, which is discussed below.

At operation 414, an interactive visualization of the 3D report is displayed. Operation 414 can include loading the generated 3D report in an AR or VR environment, and rendering, on a user device (e.g., a mobile device with a VR or AR headset) a visualization of the 3D report.

As shown, operation 414 can include displaying a 3D report that includes the 3D model. Operation 414 can include displaying the 3D report in an interactive, graphical user interface. The interface can include selectable controls for receiving user interactions with the 3D report (see, e.g., controls 710-720 of FIG. 7). As depicted in FIG. 4, operation 414 can include displaying an interactive visualization of the 3D report that includes the 3D data model.

Operation 414 can include rendering the report based on hardware visualization. For example, the report display can be based on resolution of the user device's display unit and the shape and dimensions of the display unit (e.g., curved, linear, aspect ratio). The target user device can be any mobile device, laptop, tablet device, or desktop computer. The display device can be a dashboard including one or multiple screens.

In a VR environment, the display device used in operation 414 can include a VR headset having one or more of: a stereoscopic head-mounted display that provides separate images for each eye; audio input/output devices that provide stereo sound and receive voice inputs; touchpads, buttons, head motion tracking sensors; eye tracking sensors; motion tracked handheld controllers; and gaming controllers. The display device can be used to render a graphical user interface that includes the 3D report. The audio input/output devices, sensors, and controllers can be used to capture and modify user queries and to interact with and manipulate the 3D model included in the 3D report.

Additional details and sub-operations that can be performed to accomplish operation 414 are provided in FIGS. 5 and 6, which are discussed below.

At operation 416 a determination is made as to whether a user is interacting with the displayed 3D report. Operation 416 can include receiving user interactions with the 3D report, determining if the interactions indicate a new or modified query, capturing the new (or modified) user query in an AR or VR environment, and passing control back to operation 410 to generate the query.

If it is determined that the user is interacting with the report, control is passed to operation 410, where a new or modified query is generated based on the user interactions. The user interactions detected at operation 416 can include voice inputs, touch inputs, keystrokes, button selections, or any other types of inputs that can be received in AR and VR environments. The user interactions can indicate selection of new or modified query parameters (e.g., new measures or time periods). After the new or modified query is generated in operation 410 based on the user actions, control is passed back to operation 406 where the query is executed. Otherwise, if it is determined in operation 416 that the user is not interacting with the report, control is passed to operation 418.

At operation 418, a determination is made as to whether additional processing is to be performed. The determination in operation 418 can be based on user input requesting an additional 3D report, or user input indicating that the method 400 can be terminated. If it is determined that there is additional processing to be performed (e.g., based on user input requesting a new report), control is passed back to operation 404. Otherwise, the method 400 ends.

FIG. 5 is a flowchart illustrating a method 500 of converting two-dimensional (2D) reports into three-dimensional (3D) reports and providing interactive AR and VR visualizations of 3D models included in the 3D reports.

As discussed above with reference to operation 412 of FIG. 4, operations of the method 500, namely operations 502-506, can be performed to convert a raw 2D report into a 3D report.

At operation 502, a raw report in a 2D format can be received. In the example of FIG. 5, operation 502 can include receiving a report in a file format such as an Excel spreadsheet.

At operation 504, data points from the raw report can be converted into 3D polygons with different textures, where the polygons are scaled to have the same scale. In the example of FIG. 5, operation 504 can use an OpenGL or OpenGL for Embedded Systems (OpenGL ES) API to perform the conversion and scaling. As shown, operation 504 also includes dynamically generating a 3D report that includes one or more 3D models. Additional details and sub-operations that can be performed to accomplish operation 504 are provided in FIG. 6, which is discussed below.

In operation 506, the format of 3D model can include other 3D formats besides the example OBJ geometry definition file format (OBJ) and the lib3ds library (3DS) formats shown in FIG. 5. That is, other formats can be also outputted using the method 500. For example, operation 506 can output a 3D report that includes one or more 3D models having an Open Asset Import Library (Assimp) format or a 3ds Max format, in addition to the OBJ and 3DS formats depicted in FIG. 5.

At operation 508, the 3D report is obtained before visualizing the report in either an AR environment (operation 510) or a VR environment (operation 514). As shown, operation 508 can include obtaining one or more 3D models included in the 3D report.

At operation 510, an AR visualization of the 3D report and its included one or more 3D models is generated and displayed. Operation 510 can include rendering the AR visualization in a graphical user interface of a user device. The interface can include selectable controls usable to interact with the visualization and the one or more 3D models. Example AR visualizations of 3D models that are rendered with selectable controls are depicted in FIGS. 7 and 8.

At operation 512, user interactions with the 3D report are received in the AR environment. As shown, operation 512 can include receiving user interactions via the graphical user interface (GUI) used to render the 3D report. The user interactions can include interactions with the selectable objects displayed with the 3D report.

At operation 518, a user can write a query as a marker. In the AR environment, the user query can be the marker, and the query text is extracted from marker and corresponding 3D report is generated and mapped to the marker. Then, control is passed to operation 520. As shown, the query can also be markerless, in which case operations 520-524 are not needed.

At operation 520, the user can show the marker from operation to a camera of the user's device in order to capture the marker. At operation 522, an image is captured by the camera. The image includes the marker with the user query. At operation 522, the marker can be supplemented by a geographic marker captured by a camera of the user's device. For example, the image can include geo-tagged location captured by the camera of a mobile phone, tablet device, or other user device that includes a camera and geolocation services such as GPS.

At operation 524, a user query is extracted from the captured image. For example, text recognition can be used to recognize text of the user query in the image captured by the user device's camera.

As noted above, in an AR environment, the method 500 can perform markerless loading of a 3D model too. In this case, speech or user events can be used as input to load the 3D model. See, e.g., operations 518, 520, 522, and 524. While not explicitly shown in FIG. 5, the markerless loading of the 3D model can be performed by method 500 too.

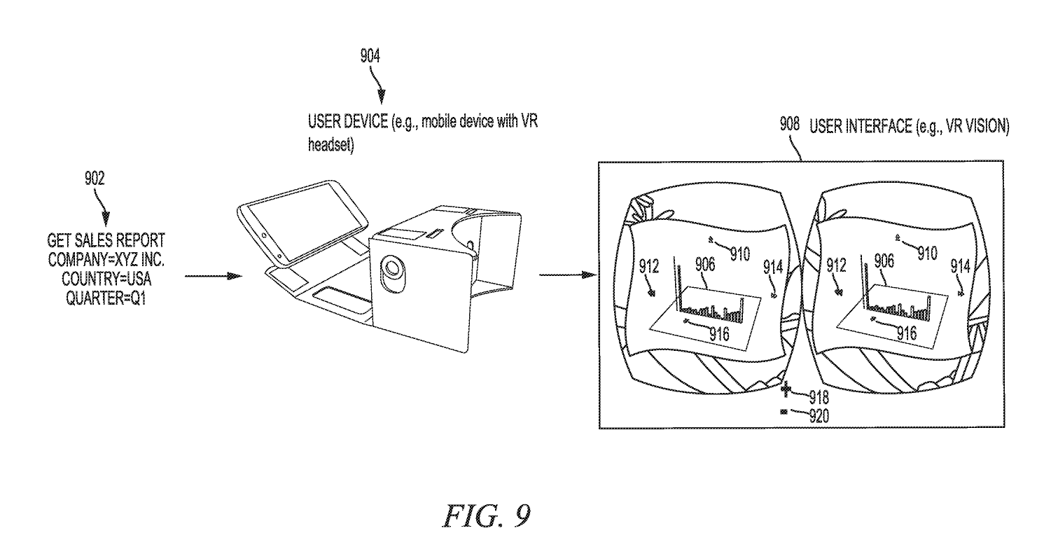

In a VR environment, at operation 514, a VR visualization of the 3D report and its included one or more 3D models is generated and displayed. Operation 514 can include rendering the VR visualization in a graphical user interface of a user device that includes a VR headset. The interface can include selectable controls usable to interact with the visualization and the one or more 3D models. Example VR visualizations of 3D models that are rendered with a VR headset and that include selectable controls are depicted in FIGS. 9-12 and 14.

At operation 526, user events that include interactions with the 3D report are received in the VR environment. As shown, operation 526 can include receiving user interactions via the graphical user interface (GUI) used to render the 3D report.

At operation 526, user events are received. As shown, these events can include speech/voice inputs from a user wearing a VR headset, touch inputs, and visual inputs from the user.

At operation 528, a query is constructed based on selections indicated by the received user events.

FIG. 6 is a flowchart illustrating a method 600 of converting data points from 2D reports into 3D data models.

At operation 602, data is extracted from a 2D report. At operation 604, the scale required for 3D dimensions based on the extracted data is calculated.

At operation 606, the data points for the extracted data are plotted in 3D space, and then control is passed to operation 608 to determine if more data points are to be plotted. Operation 608 continues passing control back to operation 606 until all data points have been plotted in 3D space.

At operation 610, texture is added to the generated polygons in order to differentiate the polygons when they are displayed in a 3D model included in a 3D report.

At operation 612, scale information in 3D is added before control is passed to operation 614, where the 3D report and its included one or more 3D models is saved in a 3D format.

In operation 614, the format of the one or more 3D models can include other formats besides the example OBJ and 3DS formats shown in FIG. 6. That is, other 3D formats, such as, for example, an Open Asset Import Library (Assimp) format and a 3ds Max format can be also added using the method 600.

In some embodiments, the methods 400, 500, and 600 can also perform context sensitive loading of 3D models. For example, the 3D models can be created and loaded based on user context from one or more of: a time; a time zone (e.g., a time zone where a user device is located); a date; a location (e.g., a geographic location where a user device is located); a user's browser history; context from paired devices either through Bluetooth, WiFi, or Infrared; context from the user's social media posts, tweets, whatsapp messages, or other app scribes and communications; context from contacts stored in the user's device; previous user input queries; events around the current location; and language of the user as an optional context.

In certain embodiments, loading of the 3D model can be based on hardware visualization. For example, loading and rendering of the 3D model can be based on one or more of: a resolution of the user device's display unit; a shape of the display unit (e.g., curved, linear, aspect ratio); or other characteristics of the user device and its display unit. In some embodiments, the target user device can be any mobile device, phone, tablet, computer or a dashboard of single or multiple screens.

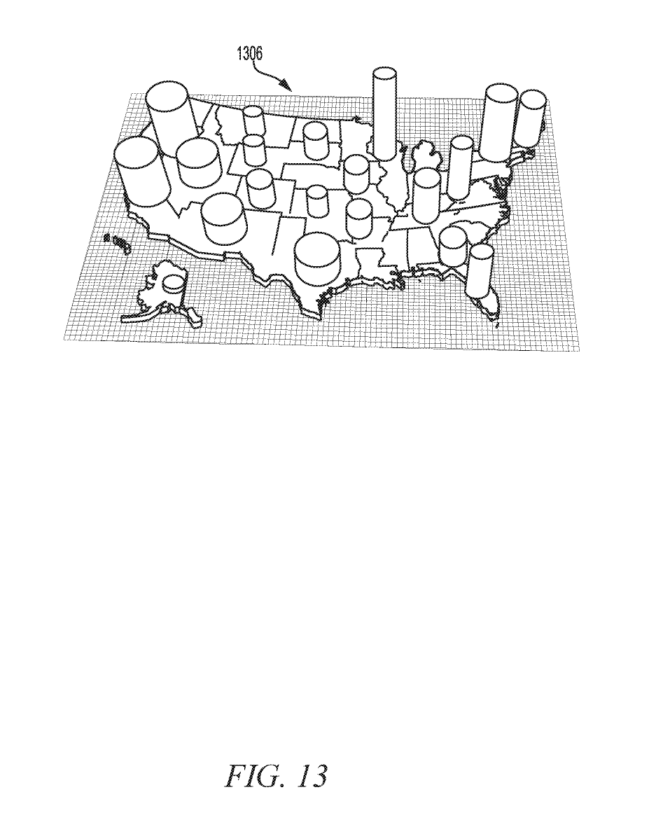

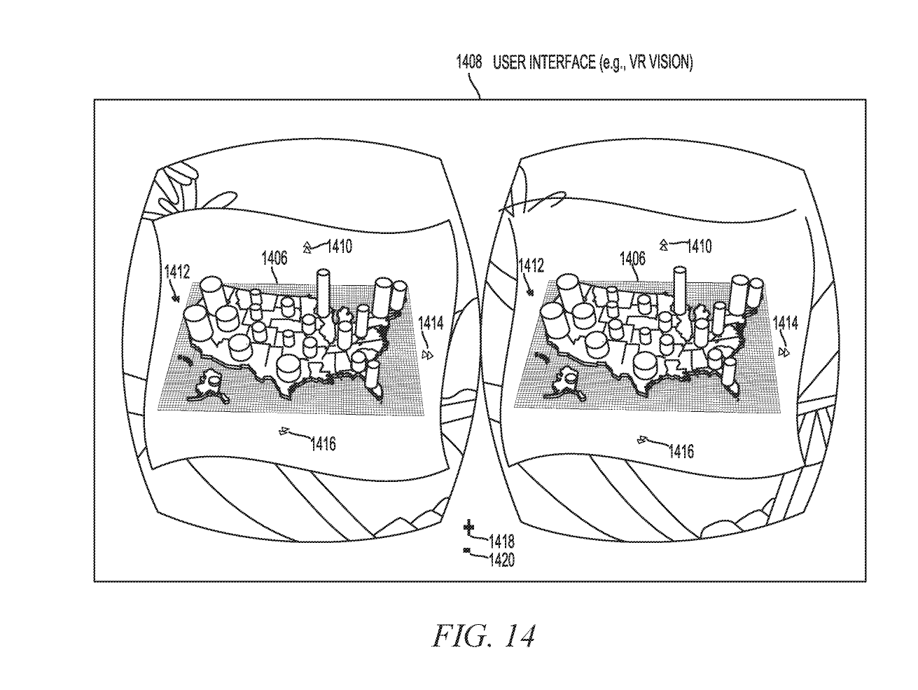

In some embodiments, the 3D model loaded is not only one model. For instance, embodiments support an environment of multiple of 3D models for both AR and VR. For example, as shown in FIGS. 13 and 14, a loaded 3D model can consist of a map of US with sales and revenue and charts on top of the map. As shown in FIGS. 7-12 and 15, embodiments can render a variety of 3D graphs and histograms. In additional or alternative embodiments, other types of 3D visualizations, such as, for example, pie charts and donut charts, can also can be generated. More user-friendly models can be generated based on user inputs. For example, in the user input query, the methods 400, 500, and 600 can obtain a user's input parameter of a desired chart type for an output model. If no input parameter is received from the user to select the output model, the analytics engine can decide on the better choice of the 3D model to the displayed to the user. In some embodiments, this decision can be calculated dynamically. This dynamic calculation can be based on the type of analytics measure requested in the query, the range of values in the query results, and the characteristics of a target display device that is used to render the 3D model.

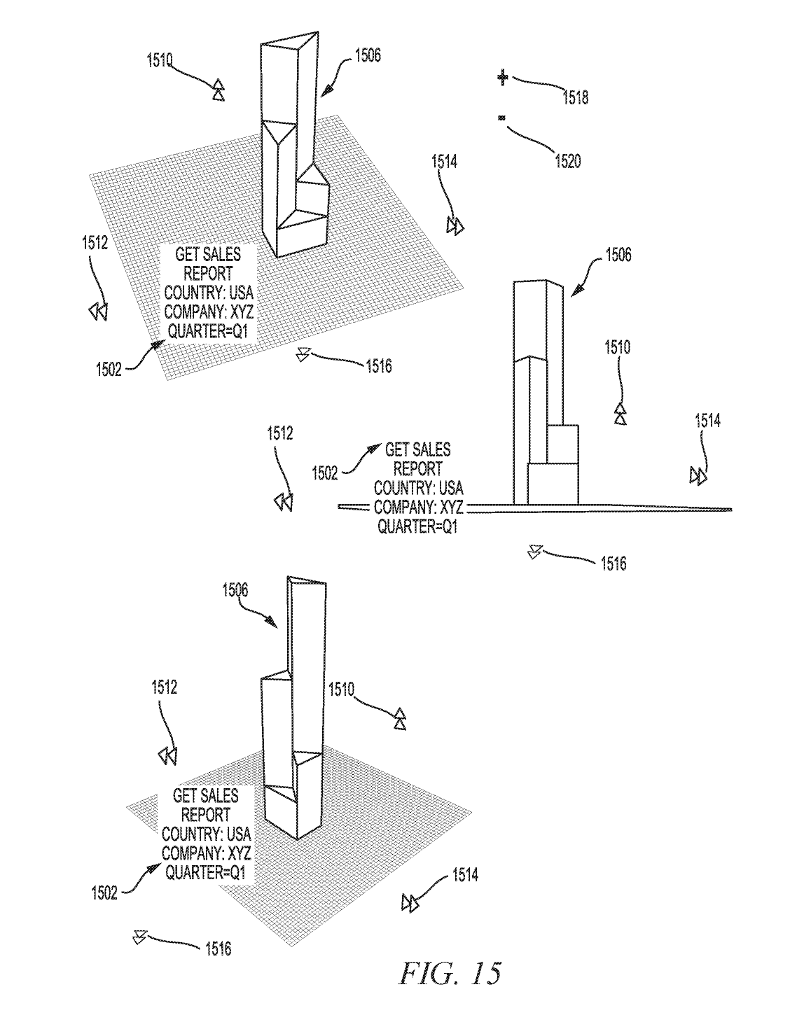

In some embodiments, interactions between user and loaded 3D model can be detected and used to modify the 3D model. For example, selections of dimensions and desired analytics measures can be selected by the user by interacting with a displayed 3D model. Also, for example, the user can zoom in and out of the 3D model, and rotate the 3D model for better view as shown in FIGS. 8 and 15. Additionally, text corresponding to automated speech can be displayed or superimposed on the 3D model from a mobile application used to present the model to the user. In some embodiments, such automated speech can be played to the user by an audio output device such as, for example, a speaker, ear bud, or head phone included in a user device, while the 3D model is displayed using a mobile application running on the user device.

In certain embodiments, multiple 3D models can be presented to the user simultaneously. For instance, embodiments can render multiple 3D models in both AR and VR environments. In an example, a user can provide inputs to select a more user-friendly or relevant model from amongst the multiple models, and the selected model will then be displayed as the primary model. The user can also provide inputs to toggle between AR and VR environments to view the model(s). When a toggle input is received to toggle between an AR visualization (e.g., an AR view) of 3D model and a VR visualization (e.g., a VR view), the request can be forwarded to an analytics engine to provide the VR view. An alternative embodiment directly switches between AR and VR views without requiring use of the analytics engine.

As shown in FIGS. 4-6, the methods 400, 500, and 600 enable cross interaction between AR to VR, or VR to AR-based 3D reports. The methods 400, 500, and 600 also allows the user to proceed for further analytics operations.

In this way, the methods 400, 500, and 600 allow interactions back and forth with analytics and AR or VR together. That is, embodiments provide integration of AR and VR on an analytics engine. Embodiments can be used in any analytics products irrespective of their respective platforms and technologies. The generation of 3D reports from raw 2D reports can be performed dynamically. User Interaction between reports in AR or VR environments on top of an analytics platform is enabled by an analytics engine. Also, in the AR environment, the user query can be the marker, the query text is extracted from marker and corresponding 3D report can be generated and mapped to the marker.

In the VR environment, the user query can be extracted from user events or speech or inputs. Embodiments enable cross interaction between AR- and VR-based 3D reports. For example, if a user interacts in an AR environment or world and requires reports in a VR environment or world, embodiments can generate the report in VR and vice-versa.

In certain example embodiments, an AR scenario includes input of a user query, and output as a 3D report displayed on top of the user query with user interactions enabled via selectable objects or controls displayed with the 3D report. For example, a user query can be a marker, such as an AR marker. An example of such as user query is provided below:
Get Sales Report
company=XYZ Inc.
country=USA
quarter=Q1

In some example embodiments, information is then extracted from the user query. For instance, the marker can be shown to the user using a mobile phone camera. In this example, a picture is captured, text is extracted from the image, and the text is converted to a query that an analytics platform processes. Processing operations performed by the analytics platform can include the method operations discussed above with reference to FIGS. 4-6.

FIG. 7 depicts converting 704 data points from a 2D analytics report 702 to export a 3D model 706. In the example of FIG. 7, the 3D model 706 is included in a 3D report displayed in a graphical user interface 708. The example analytics query above, SELECT * from SalesReport where company=XYZ Inc. AND country=USA and quarter-Q1, can produce an analytics result such as the 2D report 702 shown in FIG. 7. For example, an analytics product (e.g., an analytics platform or engine) can process the above query and provide the query result (e.g., analytics result) as the 2D report 702. In the example of FIG. 7, the 2D report 702 is a sales report indicating sales in US dollars for XYZ Inc.'s products in quarter Q1.

FIG. 7 shows how the converting 704 of data points from the 2D analytics report 702 is used to export and display the 3D model 706 within a 3D report in the graphical user interface 708. In the example of FIG. 7, the graphical user interface 712 includes selectable controls 710, 712, 714, 716, 718, and 720. By interacting with one or more of the selectable controls 710, 712, 714, 716, a user can rotate the 3D model 706 in order to view the model 706 from different perspectives in 3D space within the graphical user interface 708. Additionally, the user can interact with controls 718 and 720 to zoom in and out of the 3D model 706.

According to the embodiment shown in FIG. 7, the 2D report 702 is converted via conversion 704 into the 3D model 706. As shown the 3D model 706 can be rendered the graphical user interface 708 as an interactive 3D report. The conversion 704 can comprise extracting the data points from the result of the 2D analytics report 702, plotting the data points in 3D space, and then exporting the 3D model 706 using a 3D format. In certain non-limiting embodiments, the data points can be plotted in 3D space using a computer graphics API for rendering 3D computer graphics such as, for example, OpenGL, OpenGL for Embedded Systems (OpenGL ES), or other graphics-based libraries. In additional or alternative embodiments, the 3D model 706 can be exported using a 3D format such as, for example, an Open Asset Import Library (Assimp) format, a 3ds Max format, a lib3ds library format (e.g., 3DS), or other 3D formats. According to these embodiments, a variety of libraries can be used to export the 3D model 706 into various 3D model formats in a uniform manner so that the 3D model 706 can be rendered and displayed on a variety of user devices and platforms.

After the data points have been plotted in 3D space and the 3D model 706 has been exported into a 3D format, the 3D model 706 can be loaded into an AR environment. In some embodiments, this can include loading the 3D model 706 corresponding to the 2D report 702 into an AR environment that is visualized within a graphical user interface 708. In one embodiment, the AR environment is a mobile app that renders the graphical user interface 708. Then, the 3D model 706 of the 2D report 702 can be displayed over a marker. At this point, the user can interact with the 3D model using one or of the controls 710, 712, 714, 716, 718, and 720. Such interactions can enable the user to: further drill down on analytics data represented in the 3D model 706; visualize the 3D model 706 in multiple dimensions and from multiple angles (e.g., by selecting controls 710, 712, 714, and 716); toggle to a VR-based visualization; and zoom in and out of the 3D model 706 (e.g., by selecting controls 718 and 720).

FIG. 8 illustrates how an example visualization of a 3D model 806 of results of an analytics query 802 can be displayed in an interactive AR environment. For example an AR output can be the 3D bar graph visualization of 3D model 806 that includes the results of query 802, as depicted in FIG. 8. In the example of FIG. 8, the query 802 is as follows:
Get Sales Report
company=XYZ Inc.
country=USA
quarter-Q1

As shown in FIG. 8, the 3D model 806 includes the analytics results of the query 802. The 3D model 806 can be manipulated by interacting with one or more of the selectable controls 810, 812, 814, 816, 818, and 820. For instance, a user can select one or more of the controls 810, 812, 814, and 816 to rotate the 3D model 806 in order to view the model 806 from different perspectives in 3D space. In the example of FIG. 8, a user has selected (e.g., clicked on) one or more of controls 814 and 816 to rotate the 3D model 806 clockwise. In an additional example, the user can interact with controls 818 and 820 to zoom in and out of the 3D model 806.

Interactions with the 3D model 806 can be also be used to fine tune the selection of measures and the dimensions for subsequent iterations of generating and re-generating 3D reports including the 3D model 806. For instance, a user can interact with the 3D model 806 by touching or tapping a portion of the 3D model 806 in order to select measures and dimensions for further iterations of analytics visualizations.

FIG. 9 depicts an example 3D model 906 displayed as an analytics visualization in a VR environment. In particular, FIG. 9 shows how the 3D model 906 can be output on a user device 904 (e.g., a mobile device with a VR headset) as the result of a text or image query 902 in the VR environment.

In certain embodiments, the VR headset can be one or more of an Oculus Rift headset, an HTC Vive headset, a Samsung Gear VR headset, a Google Cardboard headset, an LG 360 VR headset from LG Electronics, a Sony PlayStation VR headset, or other types of VR headsets. Such VR headsets can include one or more of: a stereoscopic head-mounted display that provides separate images for each eye; audio input/output devices that provide stereo sound and receive voice inputs; touchpads, buttons, head motion tracking sensors; eye tracking sensors; motion tracked handheld controllers; and gaming controllers. Such displays can be used to render the graphical user interface 908. The audio input/output devices, sensors, and controllers can be used to capture and modify user queries (e.g., query 902) and to interact with and manipulate a 3D model corresponding to the queries (e.g., 3D model 906).

In the example embodiment of FIG. 9, a VR scenario includes receiving input of a user query 902 through user inputs or an AR marker, and then outputting the results as an interactive 3D report. In particular, outputting the interactive 3D report includes displaying the 3D model 906 in a graphical user interface 908. The graphical user interface 908 is rendered via a VR headset of the user device 904.

The graphical user interface 908 also includes selectable controls that the user can interact with. For example, objects rendered in the graphical user interface 908 can be manipulated by interacting with one or more of the selectable controls 910, 912, 914, 916, 918, and 920. For instance, a user can select one or more of the controls 910, 912, 914, and 916 to rotate the 3D model 906 in order to view the model 906 from different perspectives within the 3D space represented in the graphical user interface 908. For example, the user can select (e.g., click on) one or more of controls 910, 912, 914, and 916 to rotate the 3D model 906 clockwise and counterclockwise with respect to x, y, and z axes in 3D space. Additionally, for example, the user can interact with controls 918 and 920 to zoom in and out of the 3D model 906 within the graphical user interface 908.

As noted above with reference to FIG. 8, a user can interact with a 3D model for fine tuning selection of measures of interest and dimensions used to generate 3D reports. In the example of FIG. 9, a user can interact with the 3D model 906 within the graphical user interface 908 in order to fine tune selections of measures and the dimensions for subsequent iterations of generating and re-generating 3D reports that include the 3D model 906. For example, the user can interact with the 3D model 906 via touch inputs (e.g., a tap, a sliding input, a press) to select measures and dimensions in order to generate additional iterations of a 3D analytics visualization (e.g., a 3D report including versions of the 3D model 906).

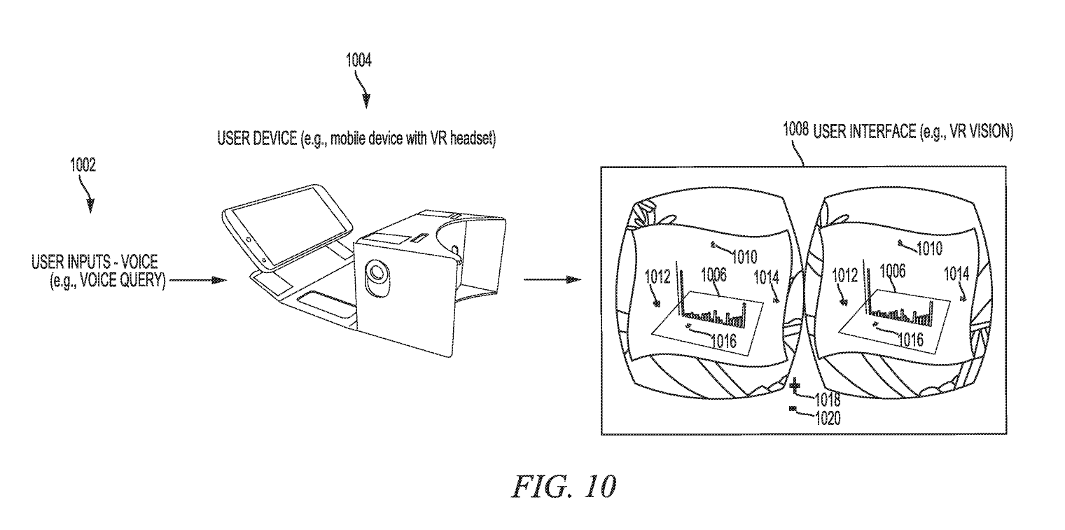

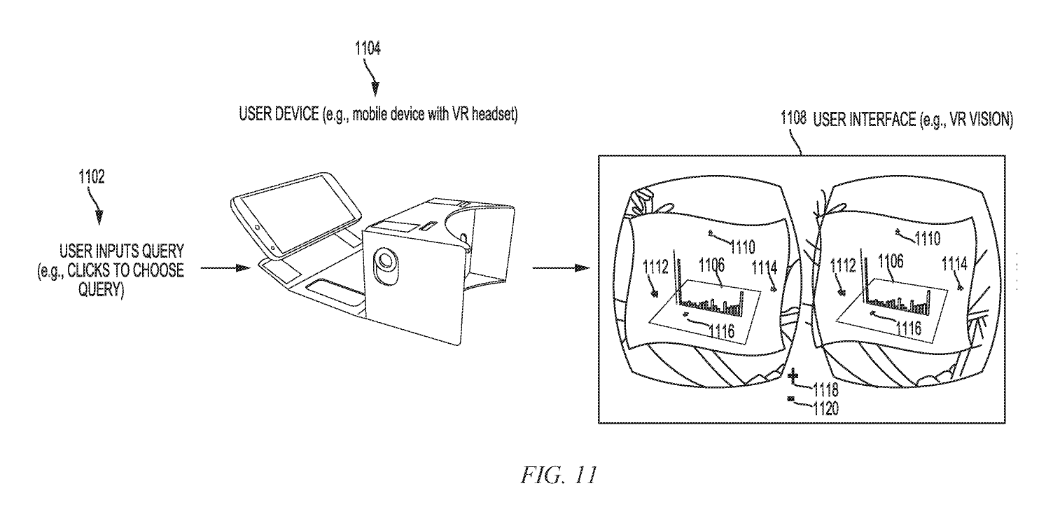

In VR environments such as the environment shown in FIG. 9, there are additional ways to pass in or receive user inputs that may not be available in AR environments. For example, in VR environments including VR headset devices, motion tracked handheld controllers, and audio input devices such as microphones, input controls for defining a query and manipulating a resulting 3D report can include gesture inputs, voice inputs, and visual inputs. For instance, an AR marker of a user query 902 rendered as text or an image can be used as an input in VR environments. Additionally, voice inputs (see, e.g., FIG. 10), visual inputs (e.g., inputs captured via head motion tracking sensors and eye tracking sensors), and user clicks (see, e.g., FIG. 11) can be used as inputs in VR to manipulate objects such as the 3D model 906, interact with objects (e.g., controls 910-920), communicate, and otherwise enable the user to experience immersive environments including the 3D model 906.

As discussed above, the user device 904 can comprise a VR headset including one or more of: a stereoscopic head-mounted display that provides separate images for each eye of a user; audio input/output devices that provide stereo sound and receive voice inputs; touchpads, buttons, head motion tracking sensors; eye tracking sensors; motion tracked handheld controllers; and gaming controllers.

In VR environments, user inputs can be an AR marker. For instance, the user query 902 in the form of text or an image can be captured by a VR headset used with a mobile device such as a smart phone. An example of this is illustrated in the user device 904 of FIG. 9 that includes a VR headset.

FIG. 10 depicts displaying an example 3D model 1006 of an analytics visualization output as the result of a voice query 1002 in a VR environment. In the embodiment of FIG. 10, the voice query 1002 can be voice input captured by a microphone of a user device 1004 with a VR headset.

In FIG. 10, the voice query 1002 is received as voice inputs from a user in a VR environment. In particular, FIG. 10 depicts how the voice query 1002 is captured at the user device 1004 (e.g., a mobile device with a VR headset) and the resulting 3D model 1006 is then rendered in a graphical user interface 1008 displayed by the user device 1004. In some embodiments, a microphone or other listening device included in the user device 1004 is configured to detect verbal commands and other voice inputs (e.g., audio signals corresponding to the user's voice) from a user of the user device 1004. The voice inputs can include query parameters for the voice query 1002. The user device 1004 can include a combination of voice recognition software, firmware, and hardware that is configured to recognize voice commands spoken by the user and parse captured voice inputs in order to generate the voice query 1002.

In addition to the voice inputs used to generate the voice query 1002, the user of the user device 1004 can provide other inputs to interact with objects displayed in the graphical user interface 1008. For instance, the user can select one or more of controls 1010, 1012, 1014, 1016, 1018, and 1020 to interact with the rendered 3D model 1006. For example, the user, via interactions with the controls 1010, 1012, 1014, 1016, 1018, and 1020 can interact with the 3D model 1006 in order rotate and tilt the 3D model 1006 (e.g., by using controls 1010, 1012, 1014, and 1016); toggle from the VR-based visualization shown in FIG. 10 to an AR-based visualization and vice versa; and zoom in and out of the 3D model 1006 (e.g., by selecting controls 1018 and 1020, respectively).

FIG. 11 depicts displaying an example 3D model 1106 of an analytics visualization output as the result of a user query 1102 input in a VR environment. In some embodiments, the user query 1102 can be one or more touch inputs, gestures, and clicks captured by an input device. For instance, the input device can be a touch pad or touch screen of a mobile user device 1104 with a VR headset, as shown in FIG. 11. The user query 1102 can be created by one or more touch inputs, inputs via motion tracked handheld controllers, stylus inputs, mouse inputs, button inputs, and keyboard inputs. For instance, a user can provide input via the user device 1104 as clicks, gestures, touch inputs, or visual inputs in the graphical user interface 1108 to build the user query 1102. Such inputs can be captured using input devices and the VR headset of the user device 1104.

In some embodiments, information is extracted from user inputs. For example, an embodiment extracts text from user inputs by converting the text to the query 902 that an analytics platform processes. The analytics platform can include an analytics engine configured to carry out steps for processing the query 902 and presenting the query results as the interactive 3D model 906 (see, e.g., the methods of FIGS. 4-6).

FIG. 11 depicts displaying an example 3D model 1106 of an analytics visualization that is output on a user device 1104 (e.g., a mobile device with a VR headset) as the result of a user query 1102 input and captured in a VR environment. In the example of FIG. 11, the user query 1102 can be entered via user inputs (e.g., clicks, touch inputs, or keystrokes). For instance, a user can use one or more of a touch pad, keyboard, pointing device (e.g., a mouse, finger, stylus, or gaming controller), or buttons to enter an analytics query. With reference to the examples of FIGS. 7-9, the analytics query is: SELECT * from SalesReport where company=XYZ Inc. AND country=USA and quarter=Q1.

In response to receiving the user query 1102, the user device 1104 forwards the query to an analytics product, such as an analytics platform with an analytics engine. The analytics product then processes the query and can provide results such as the 2D report 702 as discussed above with reference to FIG. 7. Next, the query results can be converted to the 3D model 1106. In embodiments, this conversion can include extracting data points from the result of the user query 1102, plotting the data points in 3D space using a library such as, for example, OpenGL or OpenGL for Embedded Systems (OpenGL ES), and exporting the 3D report to a 3D format that can be rendered in a graphical user interface 1108. As discussed above with reference to FIG. 7, in embodiments, such exporting can be performed using an Open Asset Import Library (Assimp) format, a 3ds Max format, a lib3ds library format (e.g., 3DS), an OBJ geometry definition file format, or another 3D format so that the 3D model 1106 can be rendered and displayed on the graphical user interface 1108 of the user device 1104.

Next, the 3D model 1106 is loaded into the VR environment. In certain embodiments, the VR environment includes the user device 1104, which can be a mobile device with a VR headset, as shown in FIG. 11. In the example of FIG. 11, the 3D model 1106 can be displayed in the graphical user interface 1108 that is a VR vision interface. The graphical user interface 1108 can be rendered by a stereoscopic head-mounted display of the VR headset. In this example embodiment, the VR headset provides separate images of the 3D model 1106 for each eye. A user wearing the VR headset can use controls 1110, 1112, 1114, 1116, 1118, and 1120 to interact with the 3D model 1106. For instance, the user, via inputs such as clicks on the controls 1110, 1112, 1114, 1116, 1118, and 1120 can interact with the 3D model 1106 in order to: further drill down to see details of the analytics report; visualize the report from multiple angles (e.g., by using controls 1110, 1112, 1114, and 1116); toggle from the VR-based visualization shown in FIG. 11 to an AR-based visualization; and zoom in and out (e.g., by using controls 1118 and 1120).

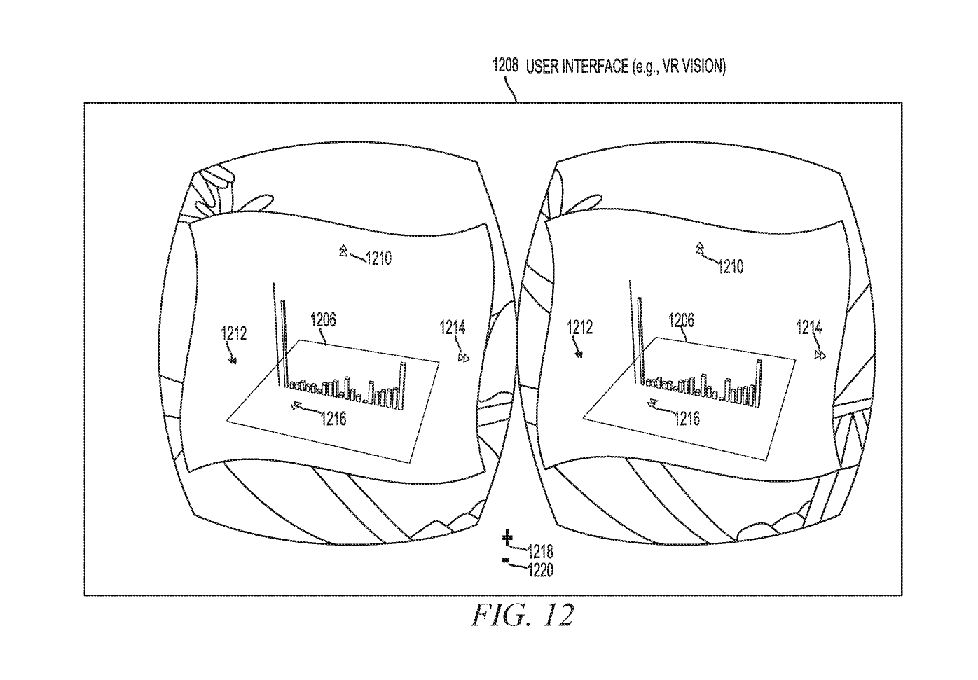

FIG. 12 illustrates an example 3D model 1206 embodied as an analytics visualization displayed in a graphical user interface 1208 within a VR environment. As shown in FIG. 12, the 3D model 1206 can be displayed as a 3D report in the graphical user interface 1208. The graphical user interface 1208 can be rendered by a stereoscopic head-mounted display that provides separate images of the 3D model 1206 for each eye. By selecting one or more of controls 1210, 1212, 1214, 1216, 1218, and 1220, a user can interact with the 3D model 1206 in order to: further drill down to see details of the analytics report; visualize the report in multiple dimensions and from multiple angles (e.g., by using controls 1210, 1212, 1214, and 1216); toggle from a VR-based visualization to an AR-based visualization; and zoom in and out (e.g., by using controls 1218 and 1220).

FIG. 13 illustrates an example 3D model 1306 that can be presented as an analytics visualization. In particular, the 3D model 1306 can be displayed in an AR environment as a 3D bar graph overlaid onto a map representing geographical areas (e.g., US states). In the example of FIG. 13, the 3D model 1306 includes bar graphs representing analytics results (e.g., sales or another analytical measure) in various US states.

FIG. 14 illustrates an example 3D model 1406 similar to the model of FIG. 13 can be displayed as an analytics visualization in a graphical user interface 1408 in a VR environment. In particular, the loaded 3D model 1406 consists of the map of US with 3D visualizations of analytics measures (e.g., bar graphs of sales or revenue figures) superimposed on top of the US states that correspond to the measures. As with the other models discussed above with reference to FIGS. 7-12, a user can interact with the 3D model 1406 by selecting one or more of controls 1410, 1412, 1414, 1416, 1418, and 1420. FIG. 15, discussed below, shows how the controls can be used to rotate and tilt a 3D model so that the user can view the model from different perspectives and angles.

FIG. 15 illustrates how an example 3D model 1506 can be rendered as an interactive analytics visualization that is displayed in an AR environment. In particular, FIG. 15 shows how a user can interact with selectable controls 1510, 1512, 1514, and 1516 to rotate the 3D model 1506 and view it from different angles and perspectives relative to an x, y, and z axis.

The dataset or analytics data used to produce 3D models can comprise a plurality of measures and a plurality of dimensions. The AR or VR visualization can comprise a graphical representation of the at least a portion of data. The at least a portion of data can comprise at least one of the plurality of measures and at least one of the plurality of dimensions. A plurality of AR and VR visualizations can be generated based on an application of interactions to the current AR or VR visualization. Each one of the plurality of AR and VR visualizations can comprise a different graphical representation of data of the dataset. Corresponding interaction controls for each one of the plurality of AR and VR visualizations can be displayed and used to receive selections via interactions with the controls for an AR or VR visualization. For a currently displayed AR or VR visualization, a plurality of selectable interaction controls corresponding to a displayed AR or VR visualization can be caused to be displayed to the user in the graphical user interface of the device.

In some example embodiments, a plurality of AR and VR visualizations for different measured values (e.g., sales, revenue, taxes, raw materials, logistics) across intervals of time (e.g., weeks, months, quarters, years) can be caused to be displayed concurrently. The AR and VR visualizations can be caused to be displayed in a first dedicated section of the user interface for AR and VR visualizations, and the plurality of selectable interaction controls can be caused to be displayed in a second dedicated section of the user interface for AR and VR visualizations. In some example embodiments, a user selection of one of the plurality of selectable interaction controls can be detected, and the graphical representation corresponding to the selected one of the selectable interaction controls can be caused to be displayed in the first dedicated section of the user interface for AR and VR visualizations.

In certain example embodiments, the plurality of measures can comprise numeric values across time. AR and VR visualizations can be rendered that represent and augment patterns of the measures. Such representation and augmentation of analytics patterns in the visualizations can be used for analysis and decision-support.

In some example embodiments, the AR or VR visualization can comprise a bar chart representation of magnitudes of quantity change for a measured quantity across time intervals.

In some example embodiments, a displayed AR or VR visualization is updated based on a user selecting at least one of a plurality of interaction controls. For instance, an AR or VR visualization can be modified based on user interactions with interaction controls selected in order to vary a chart type (e.g., change a bar chart to a donut chart). In certain example embodiments, at least one interaction control can be selected by a user to provide interactions for modifying an AR or VR visualization. For example, at least one interaction can be determined and applied to a displayed AR or VR visualization in order to update the visualization. In some example embodiments, interactions corresponding to selected interaction controls for an AR or VR visualization can be used to modify the AR or VR visualization based on at least one of: explicit user selection of a query parameter, a shape change selection, a measure (e.g., an analytics performance metric or KPI), or chart type of the corresponding AR or VR visualization.

The methods or embodiments disclosed herein may be implemented as a computer system having one or more modules (e.g., hardware modules or software modules). Such modules may be executed by one or more processors of the computer system. One or more of the modules can be combined into a single module. In some example embodiments, a non-transitory machine-readable storage device can store a set of instructions that, when executed by at least one processor, causes the at least one processor to perform the operations and method operations discussed within the present disclosure.

### Examples

Embodiments and methods described herein further relate to any one or more of the following paragraphs. As used below, any reference to a series of examples is to be understood as a reference to each of those examples disjunctively (e.g., “Examples 1-4” is to be understood as “Examples 1, 2, 3, or 4”).

Example 1 is a system that includes one or more hardware processors and a computer-readable medium coupled with the one or more hardware processors. The computer-readable medium comprises instructions executable by the processor to cause the system to perform operations for integrating augmented reality (AR) and virtual reality (VR) models in analytics visualizations. The operations include receiving a query for data from an analytics platform and processing the query. The processing includes extracting information from the query and receiving query results. The operations also include generating, based on the query results, a 2D report and converting the 2D report into a 3D model. The converting includes plotting points from the 2D report in 3D space and exporting the 3D model using a 3D format. The operations further include loading the 3D model into one or more of: an augmented reality (AR) environment; and a virtual reality (VR) environment; and then rendering, in a graphical user interface of a user device, a visualization of the 3D model.

Example 2 is the system of Example 1, where the rendering includes displaying, in the graphical user interface, a plurality of selectable controls for interacting with the visualization of the 3D model.

Example 3 is the system of Examples 1 or 2, the converting also includes: generating one or more polygons having respective, different textures; and capturing scaling information for 3D objects included in the 3D model.

Example 4 is the system of Examples 1-3, where the processing also includes: sending, to the analytics platform, the extracted information; executing, by the analytics platform, the query; and receiving, from the analytics platform, the query results.

Example 5 is the system of Examples 1-4, where: the user device is a mobile device with a VR headset including a stereoscopic head-mounted display that provides separate images of the graphical user interface for each eye of a user; the loading includes loading the 3D model into a VR environment; and the rendering includes rendering the visualization of the 3D model on of the graphical user interface.

Example 6 is the system of Examples 1-5, where the query is a voice query captured via a microphone of the user device.

Example 7 is the system of Examples 1-6, where the query is a text query captured via an input interface of the user device.

Example 8 is the system of Examples 1-7, where the query is an image query captured via a camera of the user device.

Example 9 is the system of Examples 1-8, where the data from the analytics platform is received as a data feed from the analytics platform.

Example 10 is the system of Examples 1-9, where the 3D format is one of an Open Asset Import Library (Assimp) format, a 3ds Max format, an OBJ geometry definition file format, and a lib3ds library (3DS) format.

Example 11 is a computer-implemented method for integrating augmented reality and virtual reality models in analytics visualizations that includes receiving a query for data from an analytics platform and processing the query, where the processing including extracting information from the query and receiving query results. The method also includes generating, based on the query results, a 2D report and converting the 2D report into a 3D model, where the converting includes plotting points from the 2D report in 3D space and exporting the 3D model using a 3D format. The method further includes loading the 3D model into one or more of: an augmented reality (AR) environment; and a virtual reality (VR) environment; and then rendering, in a graphical user interface of a user device, a visualization of the 3D model.

Example 12 is the method of Example 11, where the rendering includes displaying, in the graphical user interface, a plurality of selectable controls for interacting with the visualization of the 3D model.

Example 13 is the method of Examples 11 or 12, where the converting further includes: generating one or more polygons having respective, different textures; and capturing scaling information for 3D objects included in the 3D model.

Example 14 is the method of Examples 11-13, where the processing further includes: sending, to the analytics platform, the extracted information; executing, by the analytics platform, the query; and receiving, from the analytics platform, the query results.

Example 15 is the method of Examples 11-14, where: the user device is a mobile device with a VR headset including a stereoscopic head-mounted display that provides separate images of the graphical user interface for each eye of a user; the loading includes loading the 3D model into a VR environment; and the rendering includes rendering the visualization of the 3D model on of the graphical user interface.

Example 16 is a non-transitory machine-readable storage medium, tangibly embodying a set of instructions. When the instructions are executed by at least one processor, the instructions cause the at least one processor to perform operations. The operations include receiving a query for data from an analytics platform and processing the query. The processing includes extracting information from the query and receiving query results. The operations also include generating, based on the query results, a 2D report and converting the 2D report into a 3D model. The converting includes plotting points from the 2D report in 3D space and exporting the 3D model using a 3D format. The operations further include loading the 3D model into one or more of: an augmented reality (AR) environment; and a virtual reality (VR) environment; and then rendering, in a graphical user interface of a user device, a visualization of the 3D model.

Example 17 is the storage medium of Example 16, where the query is a voice query captured via a microphone of the user device.

Example 18 is the storage medium of Examples 16 or 17, where the query is a text query captured via an input interface of the user device.

Example 19 is the storage medium of Examples 16-18, where the query is an image query captured via a camera of the user device.

Example 20 is the storage medium of Examples 16-19, where the data from the analytics platform is received as a data feed from the analytics platform.

### Example Mobile Device

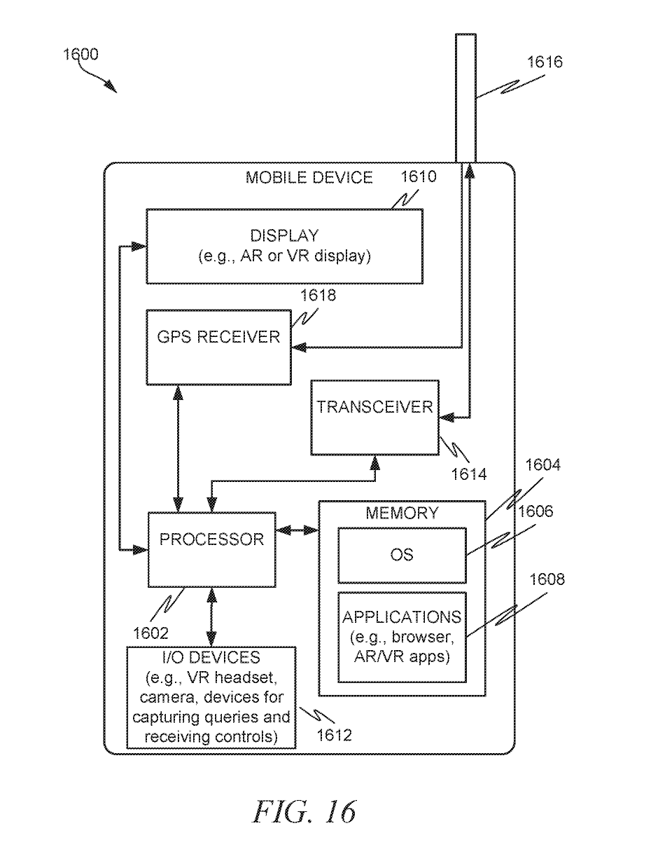

FIG. 16 is a block diagram illustrating a mobile device 1600, according to some example embodiments. The mobile device 1600 can include a processor 1602. The processor 1602 can be any of a variety of different types of commercially available processors suitable for mobile devices 1600 (for example, an XScale architecture microprocessor, a Microprocessor without Interlocked Pipeline Stages (MIPS) architecture processor, or another type of processor). A memory 1604, such as a random access memory (RAM), a Flash memory, or other type of memory, is typically accessible to the processor 1602. The memory 1604 can be adapted to store an operating system (OS) 1606, as well as application programs 1608, such as a mobile location enabled application that can provide LBSs to a user. The processor 1602 can be coupled, either directly or via appropriate intermediary hardware, to a display 1610 and to one or more input/output (I/O) devices 1612, such as a keypad, a touch panel sensor, a microphone, and the like. Similarly, in some example embodiments, the processor 1602 can be coupled to a transceiver 1614 that interfaces with an antenna 1616. The transceiver 1614 can be configured to both transmit and receive cellular network signals, wireless data signals, or other types of signals via the antenna 1616, depending on the nature of the mobile device 1600. Further, in some configurations, a GPS receiver 1618 can also make use of the antenna 1616 to receive GPS signals. In certain embodiments in an AR environment, the GPS receiver 1618 and GPS signals can be used to write a user query as a marker. The marker can then be shown to a camera (e.g., one of the I/O devices 1612) of the mobile device 1600 in order to perform operations 520 and 522 of the method 500 shown in FIG. 5.

### Modules, Components and Logic

Certain embodiments are described herein as including logic or a number of components, modules, or mechanisms. Modules can constitute either software modules (e.g., code embodied on a machine-readable medium or in a transmission signal) or hardware modules. A hardware module is a tangible unit capable of performing certain operations and can be configured or arranged in a certain manner. In example embodiments, one or more computer systems (e.g., a standalone, client, or server computer system) or one or more hardware modules of a computer system (e.g., a processor or a group of processors) can be configured by software (e.g., an application or application portion) as a hardware module that operates to perform certain operations as described herein.

In various embodiments, a hardware module can be implemented mechanically or electronically. For example, a hardware module can comprise dedicated circuitry or logic that is permanently configured (e.g., as a special-purpose processor, such as a field programmable gate array (FPGA) or an application-specific integrated circuit (ASIC)) to perform certain operations. A hardware module can also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) can be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor can be configured as respective different hardware modules at different times. Software can accordingly configure a processor, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple of such hardware modules exist contemporaneously, communications can be achieved through signal transmission (e.g., over appropriate circuits and buses) that connect the hardware modules. In embodiments in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one or more processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment or as a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the network 114 of FIG. 1) and via one or more appropriate interfaces (e.g., APIs).

Example embodiments can be implemented in digital electronic circuitry, or in computer hardware, firmware, software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments.

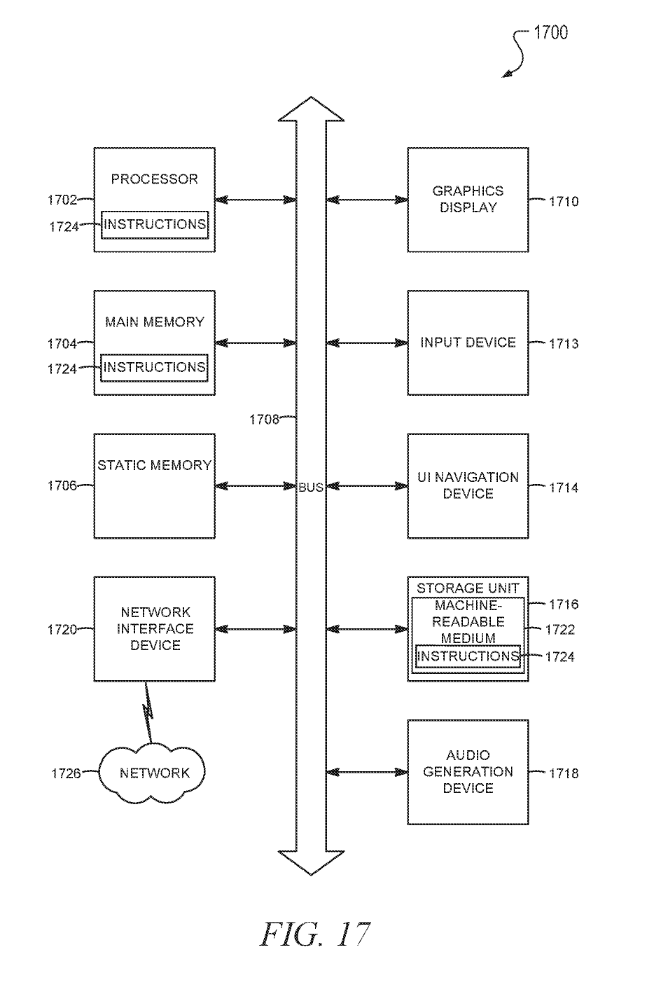

FIG. 17 is a block diagram of a machine in the example form of a computer system 1700 within which instructions 1724 for causing the machine to perform any one or more of the methodologies discussed herein can be executed, in accordance with some example embodiments. In alternative embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1702 (e.g., a central processing unit (CPU), a graphics processing unit (GPU) or both), a main memory 1704 and a static memory 1706, which communicate with each other via a bus 1708. The computer system 1700 can further include a video display unit 1710 (e.g., a liquid crystal display (LCD) or a cathode ray tube (CRT)). The computer system 1700 also includes an alphanumeric input device 1712 (e.g., a keyboard), a user interface (UI) navigation (or cursor control) device 1714 (e.g., a mouse), a disk drive unit 1716, a signal generation device 1718 (e.g., a speaker) and a network interface device 1720.

The disk drive unit 1716 includes a machine-readable medium 1722 on which is stored one or more sets of data structures and instructions 1724 (e.g., software) embodying or utilized by any one or more of the methodologies or functions described herein. The instructions 1724 can also reside, completely or at least partially, within the main memory 1704 and/or within the processor 1702 during execution thereof by the computer system 1700, the main memory 1704 and the processor 1702 also constituting machine-readable media. The instructions 1724 can also reside, completely or at least partially, within the static memory 1706.

While the machine-readable medium 1722 is shown in an example embodiment to be a single medium, the term “machine-readable medium” can include a single medium or multiple media (e.g., a centralized or distributed database, and/or associated caches and servers) that store the one or more instructions 1724 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 1724 can further be transmitted or received over a communications network 1726 using a transmission medium. The instructions 1724 can be transmitted using the network interface device 1720 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes can be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system comprising:
one or more hardware processors; and
a computer-readable medium coupled with the one or more hardware processors, the computer-readable medium comprising instructions executable by the one or more hardware processors to cause the system to perform operations for integrating augmented reality (AR) and virtual reality (VR) models in analytics visualizations, the operations comprising:
receiving a query;
extracting query parameters from the query;
sending, to an analytics platform via a network, the query parameters;
receiving, from the analytics platform via the network, query results;
generating, based on the query results, a two-dimensional (2D) report;
rendering the 2D report on a display device:
converting the 2D report into a 3D model, the converting including plotting points from the 2D report in 3D space and exporting the 3D model using a 3D format;
loading the 3D model into one or more of:
an augmented reality (AR) environment; and
a virtual reality (VR) environment; and
rendering, on the display device, a visualization of the 3D model.

2. The system of claim 1, wherein the rendering of the visualization of the 3D model includes displaying, on the display device, a plurality of selectable controls for interacting with the visualization of the 3D model.

3. The system of claim 1, wherein the converting further includes:
generating one or more polygons having respective, different textures, and
capturing scaling information for 3D objects included in the 3D model.

4. The system of claim 1, wherein the operations further comprise:
executing, by the analytics platform, the query.

5. The system of claim 1, wherein:
the system comprises a VR headset including a stereoscopic head-mounted display that provides two separate images of the visualization of the 3D model, one for each eye of a user;
the loading of the 3D model includes loading the 3D model into a VR environment; and
the rendering includes rendering the visualization of the 3D model on the two separate images.

6. The system of claim 1, wherein the query is a voice query captured via a microphone of the system.

7. The system of claim 1, wherein the query is a text query captured via an input interface of the system.

8. The system of claim 1, wherein the query is an image query captured via a camera of the system.

9. (canceled)

10. The system of claim 1, wherein 3D format is one of an Open Asset Import Library (Assimp) format, a 3ds Max format, an OBJ geometry definition file format, and a lib3ds library (3DS) format.

11. A computer implemented method for integrating augmented reality and virtual reality models in analytics visualizations, the method comprising:
receiving a query;
extracting query parameters from the query
sending, to an analytics platform via a network, the query parameters;
receiving, from the analytics platform via the network, query results;
generating, based on the query results, a two-dimensional (2D) report;
rendering the 2D report on a display device;
converting the 2D report into a 3D model, the converting including plotting points from the 2D report in 3D space and exporting the 3D model using a 3D format;
loading the 3D model into one or more of:
an augmented reality (AR) environment; and
a virtual reality (VR) environment; and
rendering, on the display device, a visualization of the 3D model.

12. The method of claim 11, wherein the rendering of the visualization of the 3D model includes displaying, on the display device, a plurality of selectable controls for interacting with the visualization of the 3D model.

13. The method of claim 11, wherein the converting further includes:
generating one or more polygons having respective, different textures; and
capturing scaling information for 3D objects included in the 3D model.

14. The method of claim 11, further comprising
executing, by the analytics platform, the query.

15. The method of claim 11, wherein:
the rendering on the display device of the visualization of the 3D model comprises rendering the visualization of the 3D model in a stereoscopic head-mounted display that provides two separate images, one for each eye of a user;
the loading of the 3D model includes loading the 3D model into a VR environment; and
the rendering includes rendering the visualization of the 3D model on the two separate images.

16. A non-transitory machine-readable storage medium, tangibly embodying a set of instructions that, when executed by at least one processor, causes the at least one processor to perform operations comprising:
receiving a query;
extracting query parameters from the query
sending, to an analytics platform via a network, the extracted query parameters,
receiving, from the analytics platform via the network, query results;
generating, based on the query results, a two-dimensional (2D) report;
rendering the 2D report on a display device;
converting the 2D report into a 3D) model, the converting including plotting points from the 2D report in 3D space and exporting the 3D model using a 3D format;
loading the 3D model into one or more of:
an augmented reality (AR) environment; and
a virtual reality (VR) environment; and
rendering on the display device, a visualization of the 3D model.

17. The storage medium of claim 16, wherein the query is a voice query captured via a microphone.

18. The storage medium of claim 16, wherein the query is a text query captured via an input interface.

19. The storage medium of claim 16, wherein the query is an image query captured via a camera.

20. (canceled)
